(19) United States
(12) Patent Application Publication
(10) Pub. No.: US 2009/0308216 A1
(43) Pub. Date: Dec. 17, 2009

(54) APPARATUS AND METHOD FOR COOLING THE CUTTING MEANS IN PAPER LOGS CUTTING MACHINES

(76) Inventor: Ciro Guarini, Calcinaia (IT)

Correspondence Address: MCGLEW & TUTTLE, PC, P.O. BOX 9227, SCARBOROUGH STATION, SCARBOROUGH, NY, 10510-9227, US

(21) Appl. No.: 12/519,856

(22) PCT Filed: Nov. 20, 2007
(86) PCT No.: PCT/IT2007/000815

§ 371 Date: Jun. 18, 2009

(30) Foreign Application Priority Data
Dec. 27, 2006 (IT) FI2006A000338

(51) Int. Cl. B26D 7/08

(52) U.S. Cl. 83/169; 83/171

(57) ABSTRACT

Apparatus for cooling the cutting means of paper logs cutting machines comprising a channel (60) surrounding the cutting means, in which channel a cooling fluid is injected, the cooling fluid being confined inside the said channel.

The present invention relates to an apparatus and method for cooling the cutting means in logs cutting machines.

It is known that logs cutting machines are used in the paper converting industry to subdivide paper logs into rolls whose length is less than that of the paper logs, i.e. into marketable standard paper rolls. The subdivision of the paper logs is carried out by means of cuts executed orthogonally to their longitudinal axis.

A conventional logs cutting machine comprises a bearing platform provided with guide channels along which the one or more paper logs to be cut are positioned, means for intermittently advance the paper logs along said guide channels, a retaining unit for retaining the paper logs during cutting, and cutting means with a blade mounted on a rotating arm. In practice, each paper log is made to advance along the respective guide channel and stopped in a position apt to execute the cut in correspondence to the retaining unit. Examples of cutting machines working according to this operative scheme are disclosed in EP 982104, WO 2006/126226 and U.S. Pat. No. 3,905,260.

During the very cutting step, the blade is subject to heating and it is consequently subject to deformations which imply undesired vibrations of the same, so that the cut of the paper log is not perfect.

In order to reduce at the minimum the negative effects of the blade heating, several cooling systems are adopted.

A known cooling method consists in cooling the entire cutting station, which is enclosed in a safety box provided to avoid the entrance of the human operators within the blade operating area. This method implies high energy consumption, thus resulting not compatible with the current production needs, since the cooling involves not only the blade but all the space delimited by the safety cabin.

Another known cooling method consists in providing a series of nozzles on the blade-holding arm, the nozzles being destined to inject air on the blade surface to obtain its cooling. This solution is quite complex from a mechanical point of view.

The main aim of the present invention is to provide a very simple, efficient and cheap cooling system.

These results have been achieved, according to the present invention, by providing an apparatus and a method having the features described in the independent claims. Further features of the present invention are the subject of the dependent claims.

Thanks to the present invention, it is possible to provide for the cooling of the cutting means in a more efficient way, with simple, cheap and reliable apparatus, ensuring reduced energy consumption and a high working regularity. Furthermore, the blade surface portion instantaneously subject to cooling is relatively high.

These and further advantages and characteristics of the present invention will be best understood by anyone skilled in the art from a reading of the following description in conjunction with the attached drawings, given as a practical exemplification of the invention, but not to be considered in a limitative sense, wherein:

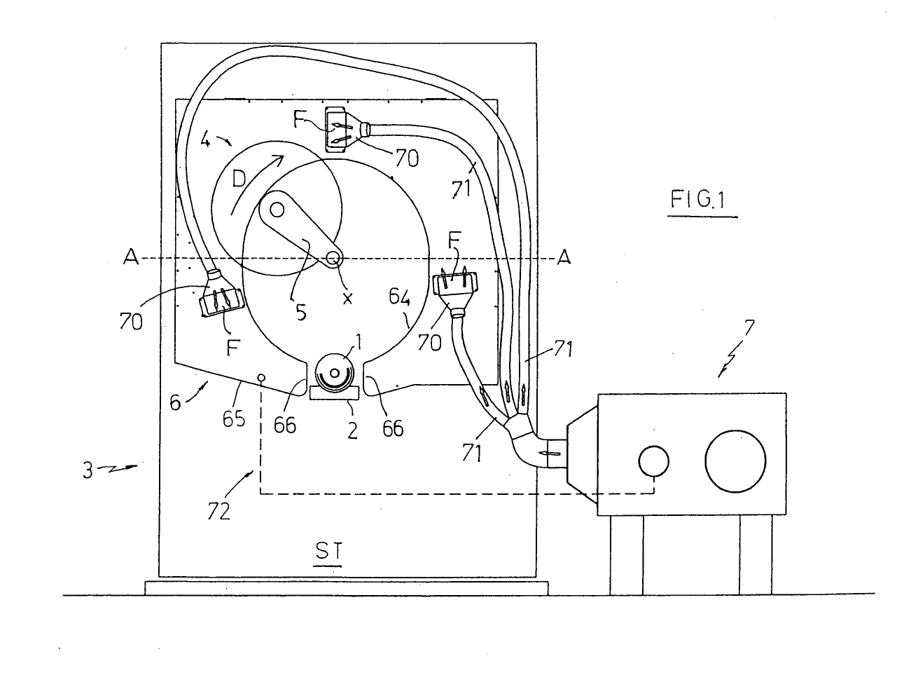

FIG. 1 is a schematic front view of a paper cutting machine in correspondence to the cutting station, wherein the cutting means comprise an orbital blade;

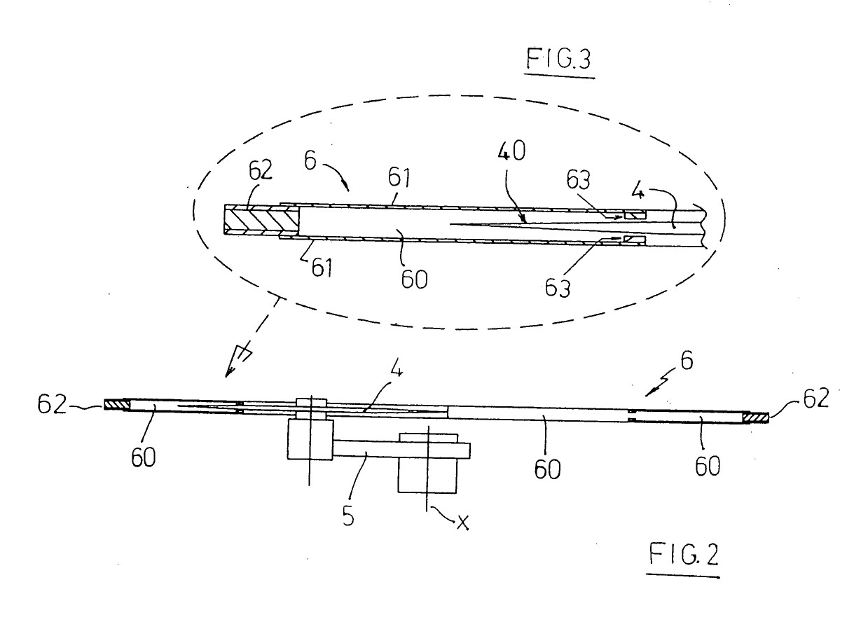

FIG. 2 is a schematic section view along line A-A of FIG. 1;

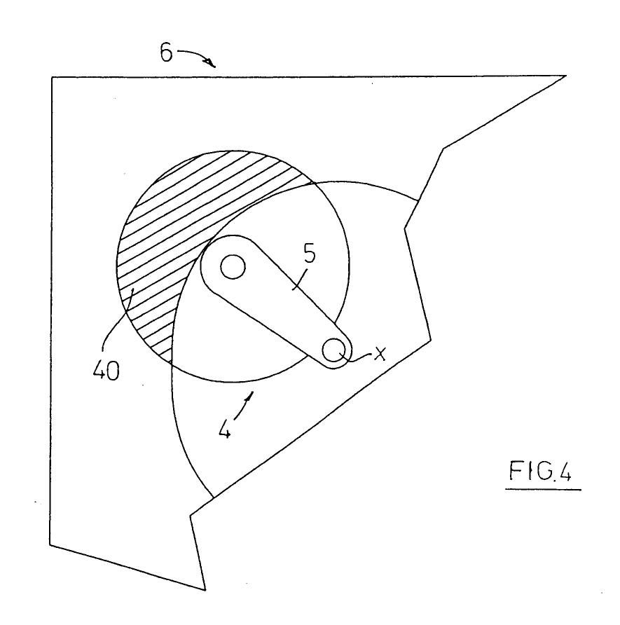

FIG. 3 is an enlarged detail of FIG. 3;

FIG. 4 is an enlarged detail of FIG. 4, wherein the dashed area represents the blade surface portion instantaneously subject to cooling.

An apparatus according to the present invention can be used, for example, in a paper logs cutting machine comprising means for guiding and advancing the logs (1) on a bearing horizontal base or platform (2), and cutting means, disposed and acting in a respective station (ST) of the machine (3) to cut each log orthogonally to the longitudinal axis thereof. In the example shown in FIG. 1 said cutting means comprise an orbital blade (4) mounted on an arm (5) which moves the blade (4) along a circular path having a predetermined radius. At each revolution of the blade (4), the latter intercepts a log (1) retained in the cutting station (ST) by a retaining mechanism (not shown in the drawings), thus cutting the log orthogonally to its longitudinal axis. After each cut, the log (1) is advanced along the platform (2) to push forward the small roll thus obtained and to prepare the same log to the subsequent cut. A paper logs cutting machine of this type is known to those skilled in the art of paper converting.

Therefore, it is not described in further details. An apparatus according to the present invention comprises a structure (6) whose walls delimit a space (60) which surrounds the path followed by the blade (4)and in which a cooling fluid is injected.

In practice, according to the example shown in the appended drawings, the said structure (6) is made by a carter with a lower interruption (to allow the positioning of the paper logs in the cutting position) which surrounds the blade (4) when the latter rotates about the axis (x) of the arm (5), thus delimiting a space surrounding the path of the blade (4) driven by the arm (5), in which space a cooling fluid is injected.

In other words, the said structure (6) delimits a channel inside which a cooling fluid is injected, the cooling fluid being thus confined close to the path followed by the blade (4). There is always a portion of the blade (4) inside the said channel. In FIG. 4 the dashed part (40) represents the surface portion of the blade (4) instantaneously subject to cooling. It is noted that there is always a relevant part (40) of the blade (4) subject to the action of the cooling fluid confined in the space surrounding the blade (4) along the path followed by the latter.

With reference to the example shown in the appended drawings, the said structure (6) comprises two side walls (61) oriented parallel to the blade (4) and to the path followed by the same blade, a peripheral edge (62) interrupted in correspondence to the platform (2), i.e. interrupted in correspondence to a zone where the logs are in the cutting position, and, on the inner side of each side wall (61), an appendix (63) which is oriented towards the inside of the structure itself and which locally reduces the transverse section of the structure without contacting the respective flank of the blade. In this way, the cooling fluid can exit from the channel-shaped space (60) flowing between the flanks of the blade (4) and the said appendixes (63). As shown in FIG. 1, each of said walls (61) has a curvilinear inner side (64) whose radius is equal to the length of the arm (5) supporting the blade (4), said inner side (64) being interrupted on its lower part to allow the correct positioning of the logs (1) to be cut on the platform (2). The said inner side (64) is prolonged downwardly by a substantially vertical portion (66) of the wall (61) connecting it with the external side (65) of the same wall (61). In practice, each wall (61) features an external side (65) surrounding the circular path followed by the blade (4) moved by the arm (5), an internal concave side (64) enclosing the area within which the arm (5) rotates, and portion (66) connecting the said external and internal sides, said portion (66) being lateral to the platform (2). The concavity of the said inner side (64) faces the platform (2), i.e. the logs (1) positioned on the latter. While rotating about the axis (x), the arm (5) moves within an area which is peripherally delimited by the curvilinear sides (64) of the walls (61) and, in part, by the platform (2). Since the blade (4) is mounted on the free end of the arm (5), a portion (40) of the blade (4) always moves within the cooled channel-shaped space (60) delimited by the walls (61).

In FIG. 1 the arrow “D” denotes the rotation of the arm (5).

For example, the cooling fluid can be air coming from a cooling unit (7) and injected in the space (60) through a plurality of sleeves (70) connected to the cooling unit (7) through respective conduits (71).

The cooling unit (7) can be of any type available on the market.

In FIG. 1 the arrows “F” denote the flow of the cooling air entered in the space (60) delimited by the structure (6). As shown in the same scheme, the cooling fluid can be entered in the space (60) directing it against the blade (4) moved by the arm (5).

A fluid return line can be provided, connecting the space (60) with the cooling unit (70) through a respective conduit (72).

An operative method according to the present invention provides for the cooling of the blade used to cut the paper logs by injecting a cooling fluid in a confined space surrounding the path followed by the blade.

Thanks to the present invention, the blade (4) moves within a cooled space whose small dimension implies a reduced energy consumption.

Practically, all the construction details may vary in any equivalent way as far as the shape, dimensions, elements disposition, nature of the used materials are concerned, without nevertheless departing from the scope of the adopted solution idea and, thereby, remaining within the limits of the protection granted to the present patent.

1. An apparatus for cooling a cutting means of paper logs cutting machines, the cutting means moving along a predetermined path, the cooling apparatus comprising a channel in which a cooling fluid is injected, the cooling fluid being confined inside said channel, wherein said channel surrounds the cutting means and delimits a confined space surrounding the path followed by the cutting means.

2. An apparatus according to claim 1, wherein said cutting means comprises an orbital blade and said channel surrounds the path followed by the blade.

3. An apparatus according to claim 1, wherein said channel is constituted by a structure comprising two side walls oriented parallel to the path followed by the blade, a peripheral edge interrupted in correspondence to a zone where the logs are ready to be cut, and, on the inner side of each side wall, an appendix.

4. An apparatus according to claim 1, wherein said channel exhibits an exit section for the cooling fluid.

5. An apparatus according to claim 1, wherein the cooling fluid is air coming from an air cooling unit which is injected in said channel by means of sleeves connected to the cooling unit by means of respective conduits.

6. A method for cooling a cutting means of paper logs cutting machines, the method comprising:
cooling of said cutting means by injecting a cooling fluid in a confined space surrounding a path followed by the cutting means.

7. A method according to claim 6, wherein the cooling fluid is injected in said confined space against the direction followed by the cutting means.
